(19) United States
(12) Patent Application Publication
(10) Pub. No.: US 2006/0026018 A1
(43) Pub. Date: Feb. 2, 2006

(54) System and method for determining eligibility for multiple programs

(76) Inventors: Bryan J. Exner, Bloomingburg, NY (US); Margaret Turner, West Newton, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/075,541

(22) Filed: Mar. 8, 2005

Related U.S. Application Data
(60) Provisional application No. 60/551,185, filed on Mar. 8, 2004.

(51) Int. Cl. G06Q 99/00

(52) U.S. Cl. 705/1

(57) ABSTRACT

A system and method is provided for determine eligibility by an applicant to multiple programs. Specifically, a system and method is provided that requires less effort by the applicant for applying to multiple programs. In one example, an applicant screening and application process are combined in a single interview. In another example, duplicative information required among multiple programs is collected one time, versus conventional methods that require separate data collection processes for each program. Further, after minimum set of data items is determined, an order is determined that uses data dependencies to limit the amount of data collected.

### RELATED APPLICATIONS

This application claims priority under 35 U.S.C. § 119(e) to U.S. Provisional Application Ser. No. 60/551,185, entitled “SYSTEM AND METHOD FOR DETERMINING ELIGIBILITY FOR MULTIPLE PROGRAMS,” filed on Mar. 8, 2004 which is herein incorporated by reference in its entirety.

### BACKGROUND OF THE INVENTION

1. Field of the Invention

The present invention relates generally to data entry systems, and more particularly, to computer systems for determining eligibility requirements.

2. Related Art

Systems are used for determining the eligibility of a candidate for government or other type of assistance programs (e.g., food stamps, medical insurance programs, child care programs, etc.). These systems are generally computerized systems or computer-assisted interview methods that accept a number of criteria from the candidate, and assist the user in filling out an application. The application may be, for example, filled out electronically by an applicant or filled out by hand by the applicant, and subsequently input to a computer system using scanning or other manual methods.

### SUMMARY OF THE INVENTION

An improved system and method is provided for determining eligibility by an applicant to one or more programs. Using conventional computer-based and manual application methods, it may not be clear to a particular applicant which programs are available to the applicant. This occurs because, at least in part, an applicant must fill out an application to apply for the program. However, the application process is time consuming for the applicant, and because of this, an applicant will only apply for one or two programs. Because there may be programs for which the applicant may be entitled, but not applied for by the applicant, the applicant may rely on other forms of assistance or programs that may be more expensive (e.g., Medicare). As a result, there may be much more or a burden placed on certain programs, and under-utilization of others. One aspect of the present invention allows an applicant to determine his/her eligibility for multiple programs.

According to another aspect of the present invention, a system and method for determining eligibility and generates applications is provided that requires less effort by the applicant. According to one aspect of the present invention, it is realized that applying for multiple programs may require completion of multiple applications, and therefore, there is an overlap in the type of information needed for each application. Also, it is realized that an applicant (or other person that fills out an application) must fully complete each application, and the completion of each application may require multiple interviews, one for each type of application.

Alternatively, there may some initial screening wherein only some of the necessary information is obtained from an applicant to determine eligibility, and if eligibility is determined, the applicant is required to fill out an application. This additional step requires the applicant to provide duplicate information, and generally requires more than one information gathering session to complete the entire process. To screen and apply for additional programs, additional screening and application sessions are generally required, thereby lengthening the process for the applicant. For these reasons, the number of applications completed (and therefore, programs applied for) is reduced.

According to one aspect of the present invention, a system and method is provided for conducting a single interview to obtain the necessary information to complete multiple program applications. In one aspect, the single interview does not include duplicative information—that is, information that is common to multiple applications is collected once, thus reducing the time and effort needed to complete the multiple applications. Because information for multiple applications is obtained in a single interview, the utilization of programs for which the applicant may be entitled is increased. According to another aspect of the present invention, the screening process for determining whether an applicant is eligible is combined with the application process. In this manner, the time needed to determine applicant eligibility and complete one or more applications is reduced.

To further reduce the time needed to complete multiple applications, questions posed to the applicant are ordered in a predetermined order that reduces the number of questions asked. For instance, if the decision to ask a second question is dependent upon the outcome of a first question, the second question is asked after the first question, and only if the outcome of the first question indicates that the second question should be asked. Such a dependency between multiple questions of multiple applications is realized and stored by a system that assists a user in conducting an interview.

A data structure that determines how questions should be posed to the applicant may be, for example, a tree-like data structure that represents pieces of information gathered as branches and leafs in the tree. Dependencies between data elements are represented by connections flowing outward towards the leaves. Core questions that determine whether additional questions are asked are located nearer to the trunk of the data structure while less dependent pieces of information are located farther from the trunk. The data structure may be adapted to store multiple dependencies between questions. In one simple example, if the answer to a first question (question one) is “NO” and the answer to a second question (question two) is “YES”, a third question (question three) may be asked, otherwise, with another combination of answers for questions one and two, question three may be irrelevant. Such a data structure may be used by a system to determine a minimum length (or at least, a reduced length) interview for multiple program applications. Optimally, no redundant questions or unnecessary questions are asked of an applicant.

In another aspect of the present invention, a system is provided that is flexible such that additional programs may be added. In this manner, such a system may be beneficial to a number of entities (e.g., government, hospitals, and insurance companies) that may need a flexible system for assessing an applicant's eligibility to multiple programs. Such flexibility is also desired as program eligibility requirements change. In another aspect, the system is capable of generating, for each of the programs it supports, an interview including questions that may be presented to an applicant. At the end of the interview, a determination is made, based on the answers provided by the applicant of which programs supported by the system the applicant is eligible. In this manner, the applicants needs only complete a single interview to determine which programs the application is eligible. Further, according to another embodiment, information collected from the single interview is used to generate one or more applications for which the applicant is determined eligible.

In one aspect of the present invention, in a computer system, a method is provided for determining eligibility requirements for a plurality of programs. The method comprises acts of storing, for a plurality of programs, a respective plurality of questions for each of the plurality of programs, and determining, for at least two of the plurality of programs, an interview comprising a first set of questions, the first set of questions including a minimum set of questions that fulfill application requirements for the at least two of the plurality of programs.

According to one embodiment of the invention, the act of determining an interview comprises an act of determining one or more redundant questions among the respective plurality of questions for the at least two of the plurality of programs. According to another embodiment, the method further comprises an act of determining a dependency between at least two of the minimum set of questions. According to another embodiment, the act of determining a dependency includes an act of determining an order that the at least two of the minimum set of questions should be presented to an applicant. According to another embodiment, the minimum set of questions includes a minimum set of questions needed to complete an application for each respective one of the at least two of the plurality of programs, and to determine eligibility for the at least two of the plurality of programs. According to another embodiment of the invention, the method further comprises an act of presenting the minimum set of questions to an applicant within a single interview session. According to another embodiment, the act of presenting further comprises an act of generating one or more interfaces including the minimum set of questions. According to another embodiment, the method further comprises an act of storing the dependency in a memory of the computer system.

According to one embodiment of the invention, the act of storing the dependency includes storing a relation between the at least two of the minimum set of questions in the memory of the computer system. According to another embodiment, the method further comprises an act of collecting, from the applicant, answers to the minimum set of questions. According to another embodiment, the method further comprises an act of determining eligibility of the applicant to the at least two of the plurality of programs based on the collected answers to the minimum set of questions. According to another embodiment, the act of determining eligibility further comprises an act of determining that the applicant is eligible for one of the at least two of the plurality of programs, and wherein the method further comprises an act of preparing an application document including application information from the collected answers to the minimum set of questions, the application information being relevant to the one of the at least two of the plurality of programs. According to another embodiment, the act of preparing the application document does not require a data collection act for collecting the application information to be performed after the act of determining eligibility of the applicant.

According to one aspect of the present invention, a computer-readable medium is provided having computer-readable signals stored thereon that define instructions that, as a result of being executed by a computer, instruct the computer to perform a method for determining eligibility requirements for a plurality of programs. The method comprises acts of storing, for a plurality of programs, a respective plurality of questions for each of the plurality of programs, and determining, for at least two of the plurality of programs, an interview comprising a first set of questions, the first set of questions including a minimum set of questions that fulfill application requirements for the at least two of the plurality of programs. According to one embodiment of the invention, the act of determining an interview comprises an act of determining one or more redundant questions among the respective plurality of questions for the at least two of the plurality of programs. According to another embodiment, the method further comprises an act of determining a dependency between at least two of the minimum set of questions. According to another embodiment, the act of determining a dependency includes an act of determining an order that the at least two of the minimum set of questions should be presented to an applicant. According to another embodiment, the minimum set of questions includes a minimum set of questions needed to complete an application for each respective one of the at least two of the plurality of programs, and to determine eligibility for the at least two of the plurality of programs.

According to one embodiment of the invention, the method further comprises an act of presenting the minimum set of questions to an applicant within a single interview session. According to another embodiment, the act of presenting further comprises an act of generating one or more interfaces including the minimum set of questions. According to another embodiment, the method further comprises an act of storing the dependency in a memory of the computer system. According to another embodiment, the act of storing the dependency includes storing a relation between the at least two of the minimum set of questions in the memory of the computer system. According to another embodiment, the method further comprises an act of collecting, from the applicant, answers to the minimum set of questions. According to another embodiment, the method further comprises an act of determining eligibility of the applicant to the at least two of the plurality of programs based on the collected answers to the minimum set of questions. According to another embodiment, the act of determining eligibility further comprises an act of determining that the applicant is eligible for one of the at least two of the plurality of programs, and wherein the method further comprises an act of preparing an application document including application information from the collected answers to the minimum set of questions, the application information being relevant to the one of the at least two of the plurality of programs. According to another embodiment, the act of preparing the application document does not require a data collection act for collecting the application information to be performed after the act of determining eligibility of the applicant.

The function and advantage of these and other embodiments of the present invention will be more fully understood from the examples described below. The following examples are intended to illustrate the benefits of the present invention, but do not exemplify the full scope of the invention.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of a general purpose computer system upon which various embodiments of the present invention may be practiced;

FIG. 2 is a block diagram of a computer data storage system upon which various embodiments of the present invention may be practiced;

FIG. 3 shows a block diagram of a system that determines eligibility requirements for a plurality of programs according to one embodiment of the present invention;

FIG. 4 shows a process for determining eligibility requirements for a plurality of programs according to one embodiment of the present invention;

FIG. 5 shows a data relationship between application form data elements of multiple programs according to one embodiments of the present invention;

FIG. 6 shows a class diagram for organizing data relating to a targeted interview for multiple programs according to one embodiment of the present invention;

FIG. 7 shows a UML diagram that displays logic and messages that handle reading in targeted form profiles according to one embodiment of the present invention; and

FIG. 8 shows a UML diagram displays example logic and iteration of messages that handle subcategory skipping according to one embodiment of the present invention.

### DETAILED DESCRIPTION

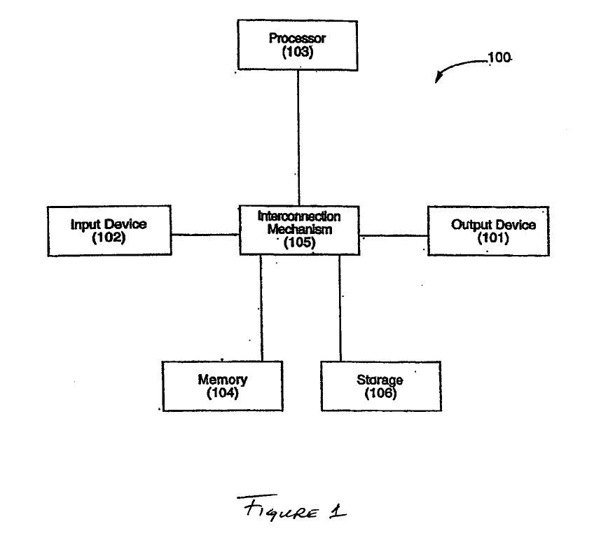

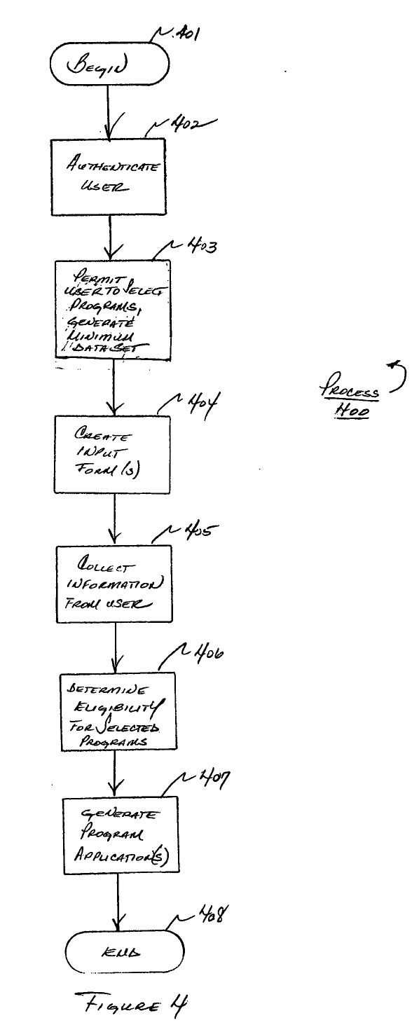

FIG. 3 shows an example system 300 that may be used to determine eligibility of an applicant for multiple programs according to one embodiment of the present invention. In the example architecture shown, the system includes an Internet or other network-based application executed among one or more computer systems (e.g., computer systems 301, 302). These computer systems may be, for example, general purpose computer systems as discussed below with reference to FIG. 1.

System 301 may be, for example, a server-based system that executes a manager application 306 (referred to herein as manager 306) which performs functions of the eligibility requirements system. For instance, manager 306 may accept input from users (e.g., users 304) operating one or more client systems (e.g., system 302) relating to one or more programs for which the user (the applicant) is applying. To this end, system 301 may include one or more programs 308 that are downloaded and executed as client program(s) 310 on system 302. Such client program(s) 310 may present one or more interfaces to the user through which information about the applicant is gathered and transferred to manager 306. Manager 306 may store such information in a database 307. Database 307 may be a relational-type or object database as known in the art, but it should be appreciated that database 307 may be any type of database suitable for storing information.

Manager 306 may be adapted to communicate with client program 310 for the purpose of presenting an interview to the user to collect information relevant to multiple programs. Manager 306 may also be adapted to determine whether the user is eligible for the programs, and to generate, if necessary, any application form(s) used for applying for the programs for which the user is eligible.

According to one embodiment of the present invention, system 300 presents a single interview to a particular user to screen for potential eligibility for a full array of assistance programs. In one example, system 300 prompts the user at the beginning of the interview to indicate for which assistance programs the system should perform an eligibility screening.

Based on the user's response, system 300 identifies the most efficient path for an eligibility screening, prompting the user to input only those data items which are necessary to perform a potential eligibility calculation, and generates completed application forms for the programs selected.

Manager 306 may include one or more components (not shown) including a case management component (or module) that manages user information and profiles, and manages status of applications and the application process. The case management component may also manage historical information, such as application forms previously generated, previous interview information (for both completed and incomplete interviews), among other historical information.

Manager 306 may also include an eligibility engine that determines, based upon collected information, whether an applicant qualifies for a particular program. The eligibility engine may, in one example, include a set of rules used to determine whether an applicant is eligible. Such rules are generally determined and provided by the administration of a particular program. These rules may be stored in database 307 of system 301. Demographic, financial, and other data collected from the applicant are applied to the rules to determine eligibility.

Once eligibility is determined, manager 306 may be adapted to generate application forms that can be submitted to an appropriate organization. For instance, manager 306 may be capable of dynamically generating forms using information collected in the interview by populating appropriate fields in the forms. These forms may be stored for historical purpose (and associated with an applicant's case). Such forms may be printed and/or submitted to the appropriate agency. In one example, forms may be submitted electronically to an external system associated with the organization.

Manager 306 may also include a reporting component that is configured to run and store reports (both standard and ad hoc) using information stored in database 307. For instance, manager 306 may have the capability of generating reports for clients (e.g., organizations) regarding applicants for their programs. To this end, system 301 may include one or more interfaces 305 that are capable of generating such reports. Interfaces 305 may be, for example, user or programmatic interfaces, such as an Internet-based application, Application Program Interface (API), database interface (e.g., ODBC, JDBC, etc.) or any other type of interface. An administrator or other user type may be permitted to access system 301 through such interface 305.

Manager 306 may also include a security component that permits an administrator of system 300 to restrict access to data to particular users or groups of users.

Manager 306 and client programs 310 may be programmed using one or more programming languages. For instance, manager 306 and/or client programs 310 may be developed using the well-known J2EE platform available from Sun Microsystems to create a browser-based application that supports various functions related to program eligibility determination including applicant screening, application generation and storage functions. However, it should be appreciated that other programming platforms may be used.

System 300 may include a distributed application program may be constructed using a three-tier architecture, meaning that the application is split into processing layers that handle specific tasks. This type of architecture provides a clean implementation, good modularity, and additional scalability as tiers can be implemented on separate servers. However, it should be appreciated that any type of architecture may be used, and the invention is not limited to any specific architecture. In one example, tiers of the system 300 include:
1. Presentation layer
2. Business Domain layer
3. Database Persistence layer

The presentation layer may be implemented, for example, using Java Server Pages (JSP) as well-known in the art. This layer may be responsible for building and delivering user interfaces (e.g., interfaces presented by client programs 310). In one example, the business domain layer contains business domain classes that encapsulate the “business logic” of applicant screening and application processing. In another example, the database persistence layer controls storage functions of system 300, including the storing of applicant data to database 307.

In one example, system 300 includes a generic framework that specializes in handling complex data analysis (screenings), and application processing. Because a general framework is provided, the number and types of screenings and applications that can be processed using the system are unlimited. For instance, because the system is designed to be scaleable, new programs and application processes can be added as necessary. This scalable design allows custom sets of program screenings to be easily assembled to support a wide variety of client needs. To this end, a multi-tiered and distributed design of system 300 may be more scaleable than other types of architectures.

As discussed, the distributed application may be programmed using the well-known J2EE platform. Because J2EE applications are standards based, it is possible to deploy a J2EE application on a wide variety of server hardware platforms, operating systems and application servers. This flexibility provides many options for scalability. For instance, a J2EE application can be deployed using a low cost/low performance application server on inexpensive PC based servers, or the application could be deployed on a high cost high performance application server on prohibitively expensive multi-node Unix hardware. Thus, the platform can be scaled according to client needs.

The distributed application may be, for example, a Java 2 Enterprise Edition (J2EE) web browser based application. As is known, J2EE applications provide a full array of APIs to integrate and communicate with virtually any system. Also, J2EE applications are capable of communicating with databases through, for example, JDBC and ODBC. Further, J2EE applications can communicate and interface with legacy systems via messaging components or other middleware components.

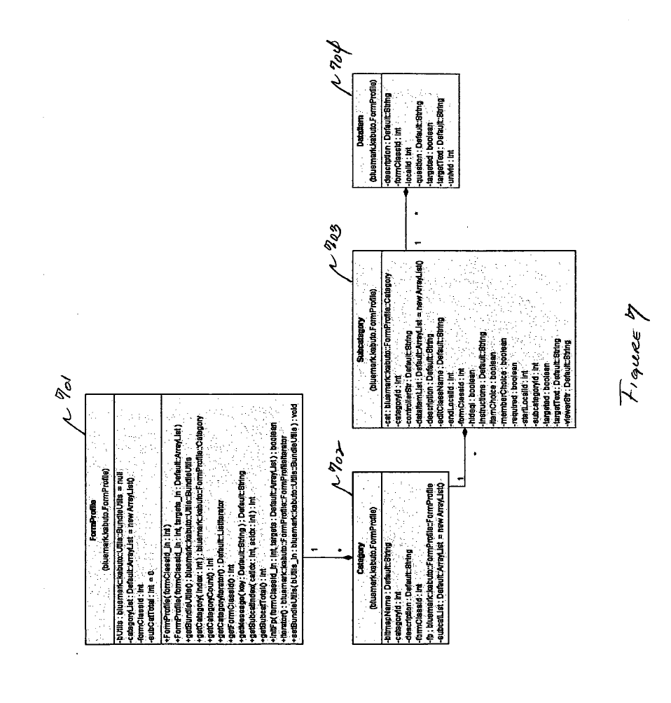

As discussed, new methods are provided for handling application screening and application generation workflows. Conventionally, screening and application generation workflows function as follows:
1. An applicant fills out a screening form. This form contains all of the data elements needed to determine potential eligibility for all supported programs. For example, the programs supported may include Food Stamps, KidCare and Child Care programs as discussed below with reference to FIG. 6.
2. At the end of the screening form, the system informs the applicant of the programs for which the applicant may be potentially eligible. For example, in the example, it may be determined that the applicant may potentially be eligible for the Food Stamps and KidCare programs.
3. At this point, the applicant generates two applications, one for Food Stamps and one for KidCare. The data elements entered on the screening form are transferred to each respective application.
4. The applicant is then required to open each generated application and proceed through another interview to collect all of the data needed for each application form.

A major problem with this approach is that as the number of applications increase, the amount of redundant data entry as the set of interviews increases. The reason for this increase is because of the way application forms are designed, they all ask the same types of questions, but, the questioning and data elements can be very different and have different formats.

According to one aspect of the present invention, a method is provided that presents a single interview to screen for potential eligibility and apply for a full array of assistance programs. In general, the user is prompted at the beginning of the interview to indicate for which assistance programs the system should perform an eligibility screening. Based on the user's response, the most efficient path is identified for an eligibility screening, and the user is prompted to input only the data items that are necessary to perform a potential eligibility calculation. Also, completed application forms are generated for the programs selected.

According to one aspect of the invention, a single comprehensive interview is used which comprises every data item needed to fully complete each application form used to apply for assistance programs supported by the system (e.g. system 300), and every data item which is required to make a potential eligibility determination.

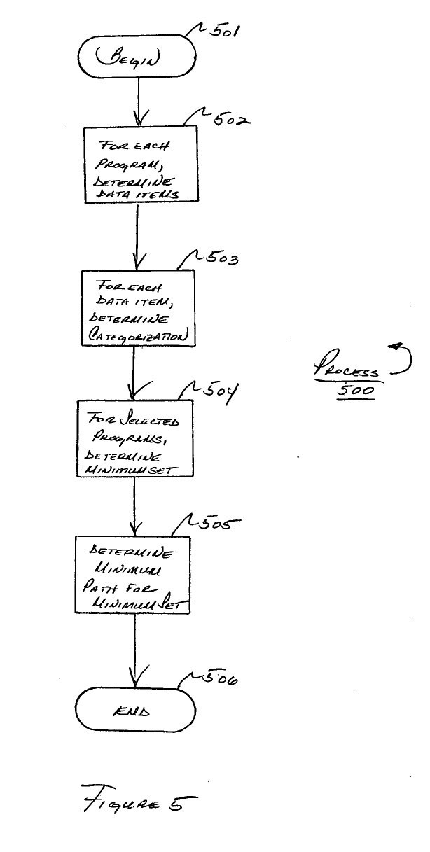

FIG. 4 shows an example process 400 for determining eligibility requirements for a number of programs according to one embodiment of the present invention. At block 401, process 400 begins. At block 402, the system (e.g., system 300) authenticates a user (an applicant). This may be performed, for example, by providing, by the applicant, a username/password combination, or by any other suitable method.

Once authenticated, the user may be permitted to select one or more programs to which the user may be interested at block 403. In the case where multiple programs are selected, the system may determine a minimum data set of items to be collected from the user. At block 404, the system may create one or more input forms based on the set of data items that need to be collected. In one example, dependencies between data items may affect the order by which the data items are collected. In one specific example, relations between data items may be identified (e.g., heuristically) and stored in a data structure which may then be used to determine the order by which the data items are collected. Answers to particular questions may affect whether latter questions need to be answered based on the stored relations.

At block 405, the system may present to the user the input form(s) created at block 404. The form(s) may include one or more fields in which the user may input data. The input data is then submitted (e.g., by selecting a “submit” or similar control presented to the user in the input form).

At block 406, the system may determine, based on the collected information, eligibility to the selected programs. This may be accomplished, for example, by evaluating one or more rules as applied to the collected information as discussed above.

If the applicant is determined to be potentially eligible for one or more programs, the system may be adapted to generate one or more program applications at block 407. This may be accomplished, for example, by placing collected data item values in fields of a form. A form, in one example, may be in electronic form (e.g., in Adobe PDF format) and stored in the system (e.g., in system 300). Once the form has been created, the form may be printed, saved, sent to the organization, among other actions.

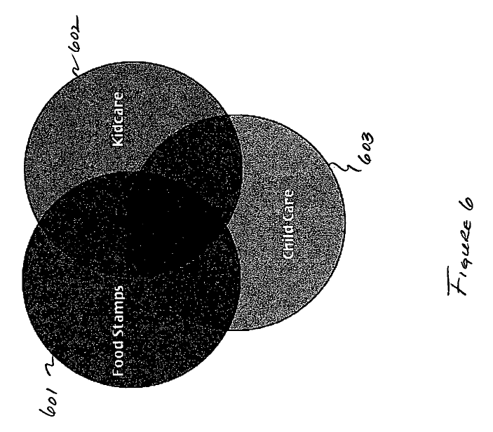

FIG. 5 shows another example process 500 for determining eligibility requirements for a number of programs according to one embodiment of the present invention. In particular, FIG. 5 shows a more detailed process for determining eligibility requirements according to one embodiment of the invention. At block 501, process 500 begins. At block 502, the system (e.g., system 300) determines the data items necessary for each program. Data items necessary for each program may be provided, for instance, manually by a programmer or analyst, and the data items may be associated with the particular program and stored in a database. As discussed, a user may select one or more programs (e.g., in block 403 discussed above with reference to FIG. 4).

The system may determine, at block 504, the minimum set of data items to be collected between multiple selected programs. In one example discussed in more detail below, categorization may be used to organize data of both programs such that the same or similar elements of each program are represented by a single data item to be collected. In this manner, redundant data collection is eliminated. At block 505, the system may determine a minimum path for collecting data of the determined minimum data set. As discussed, some data items may be dependent on other data items. As further discussed below, dependency information may be stored in the organizational structure used to store the data, and such dependency information may be used to determine whether particular data items are collected from the user. In one example, the data structure may be a tree data structure as discussed below. At block 506, process 500 ends.

It should be appreciated that processes 400, 500 may include more or less acts as shown in FIGS. 4 and 5, and that the invention is not limited to any particular number of order of acts (e.g., the order illustrated in FIGS. 4 and 5), as the acts may be performed in other orders, may include additional acts and one or more of the acts of processes 400, 500 may be performed in series or in parallel to one or more other acts, or parts thereof.

Processes 400, 500 are merely illustrative embodiments of methods for determining eligibility requirements (e.g., by a computer system). Such illustrative embodiments are not intended to limit the scope of the invention, as any of numerous other implementations for determining eligibility requirements. None of the claims set forth below are intended to be limited to any particular implementation unless such claim includes a limitation explicitly reciting a particular implementation.

Processes 400, 500, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described below in relation to FIG. 1, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

The above is merely an illustrative embodiment of a system for determining eligibility for multiple programs. Such an illustrative embodiment is not intended to limit the scope of the invention, as any of numerous other implementations of an eligibility determination system, for example, variations of system 300, are possible and are intended to fall within the scope of the invention. None of the claims set forth below are intended to be limited to any particular implementation of a system unless such claim includes a limitation explicitly reciting a particular implementation.

System 300, and components thereof such as manager 306, may be implemented using software (e.g., C, C#, C++, Java, or a combination thereof), hardware (e.g., one or more application-specific integrated circuits, processors or other hardware), firmware (e.g., electrically-programmed memory) or any combination thereof. One or more of the components of system 300 may reside on a single system, or one or more components may reside on separate, discrete systems. Further, each component may be distributed across multiple systems, and one or more of the systems may be interconnected.

Further, on each of the one or more systems that include one or more components of system 300, each of the components may reside in one or more locations on the system. For example, different portions of the components of system 300 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

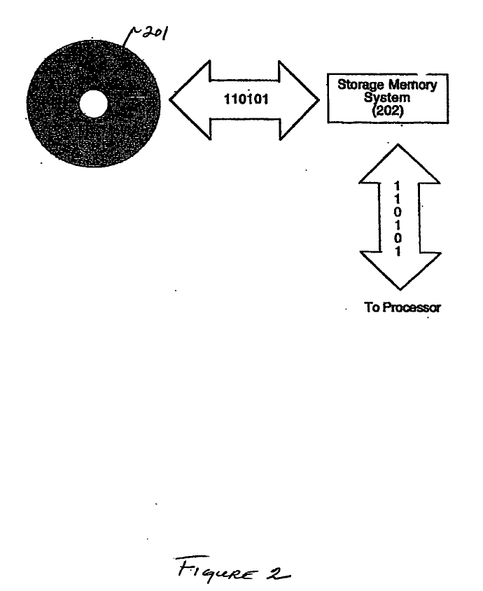

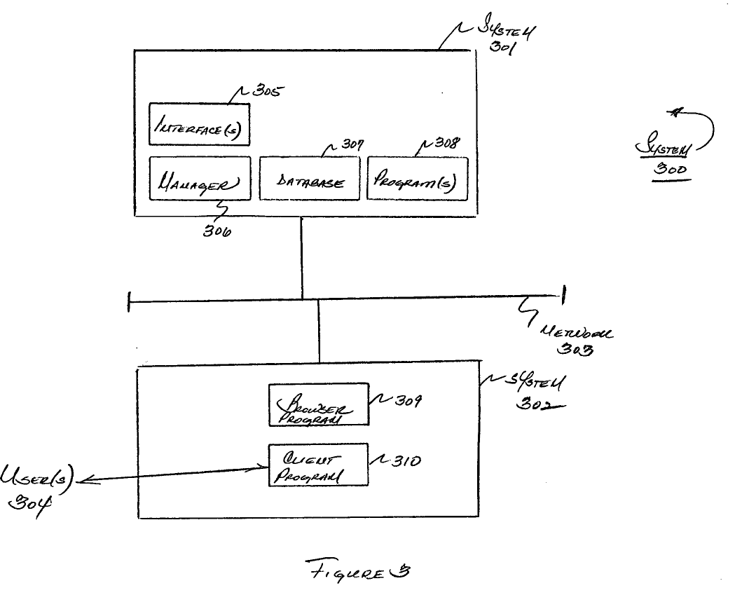

System 300 may be implemented on one or more computer systems described below in relation to FIGS. 1 and 2.

As discussed above, various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to determine eligibility requirements according to various embodiments of the invention. Further, the system may be located on a single computer or may be distributed among a plurality of computers attached by a communications network.

A general-purpose computer system according to one embodiment of the invention is configured to perform any of the described eligibility determination functions including but not limited to determining a minimum data set among multiple selected programs, generating interfaces for collecting the data, and generating application forms. It should be appreciated that the system may perform other functions, and the invention is not limited to having any particular function or set of functions.

For example, various aspects of the invention may be implemented as specialized software executing in a general-purpose computer system 100 such as that shown in FIG. 1. The computer system 100 may include a processor 103 connected to one or more memory devices 104, such as a disk drive, memory, or other device for storing data. Memory 104 is typically used for storing programs and data during operation of the computer system 100. Components of computer system 100 may be coupled by an interconnection mechanism 105, which may include one or more busses (e.g., between components that are integrated within a same machine) and/or a network (e.g., between components that reside on separate discrete machines). The interconnection mechanism 105 enables communications (e.g., data, instructions) to be exchanged between system components of system 100. Computer system 100 also includes one or more input devices 102, for example, a keyboard, mouse, trackball, microphone, touch screen, and one or more output devices 101, for example, a printing device, display screen, speaker. In addition, computer system 100 may contain one or more interfaces (not shown) that connect computer system 100 to a communication network (in addition or as an alternative to the interconnection mechanism 105.

The storage system 106, shown in greater detail in FIG. 2, typically includes a computer readable and writeable nonvolatile recording medium 201 in which signals are stored that define a program to be executed by the processor or information stored on or in the medium 201 to be processed by the program. The medium may, for example, be a disk or flash memory. Typically, in operation, the processor causes data to be read from the nonvolatile recording medium 201 into another memory 202 that allows for faster access to the information by the processor than does the medium 201. This memory 202 is typically a volatile, random access memory such as a dynamic random access memory (DRAM) or static memory (SRAM). It may be located in storage system 106, as shown, or in memory system 104, not shown. The processor 103 generally manipulates the data within the integrated circuit memory 104, 202 and then copies the data to the medium 201 after processing is completed. A variety of mechanisms are known for managing data movement between the medium 201 and the integrated circuit memory element 104, 202, and the invention is not limited thereto. The invention is not limited to a particular memory system 104 or storage system 106.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 100 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architecture or components that that shown in FIG. 1.

Computer system 100 may be a general-purpose computer system that is programmable using a high-level computer programming language. Computer system 100 may be also implemented using specially programmed, special purpose hardware. In computer system 100, processor 103 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

FIG. 6 shows an application form data map for three different example programs that may be supported by various embodiments of the present invention. As shown in FIG. 6, there may be overlap between data necessary for two or more program applications. In the example, there are three programs that can be applied for by an applicant, Food Stamps (item set 601), Kidcare (item set 602) and Child Care (item set 603). Overlap may occur, for example, between two or more data sets (e.g., between sets 601 and 602, between 601-603, etc).

According to one embodiment of the invention, a system and method is provided that allows all the data required for multiple programs to be collected in a single interview. Preferably, there is no redundant information collected. That is, application data common to two or more programs is collected one time, and this common application data is propagated to more than one program application. According to another embodiment of the invention, an eligibility screening, which conventionally is held in a separate session, is combined with the application process. In this manner, the amount of time spent by an applicant to become screened for two or more programs is decreased, and thus the likelihood that the applicant applies for more programs as a result is increased.

Data Item Organization

According to one embodiment, items are initially organized into logical groups referred to herein as categories. Data items within categories are organized furthering into subcategories. Data items within subcategories can be organized further into data sets. An example of such an organization is shown below in Table I.

Assuming that data items one through twenty comprise the full set of data items supported by the system, an example organization of the data items may be as follows:

TABLE I
Example Data Organization

| Data Item Organizational Unit | Specific Data Items |
|---|---|
| Category A | 1, 3, 5, 7, 9, 11, 13, 15, 17, |
| | 19 |
| Category B | 2, 4, 6, 8, 10, 12, 14, 16, 18, |
| | 20 |
| Category A - Subcategory 1 | 1, 3, 5, 7, 9 |
| Category A - Subcategory 2 | 11, 13, 15, 17, 19 |
| Category B - Subcategory 1 | 2, 4, 6, 8, 10 |
| Category B - Subcategory 2 | 12, 14, 16, 18, 20 |
| Category A - Subcategory 1 - Data Set 1 | 1, 3, 5 |
| Category A - Subcategory 1 - Data Set 2 | 7, 9 |
| Category A - Subcategory 2 - Data Set 1 | 11, 13, 15 |
| Category A - Subcategory 2 - Data Set 2 | 17, 19 |
| Category B - Subcategory 1 - Data Set 1 | 2, 4, 6 |
| Category B - Subcategory 1 - Data Set 2 | 8, 10 |
| Category B - Subcategory 2 - Data Set 1 | 12, 14, 16 |
| Category B - Subcategory 2 - Data Set 2 | 18, 20 |

In the example above, data items are grouped into organizational units. These organizational units are either presented or not presented based on what information needs to be collected in the screening or are “targeted”. Assuming that there are two assistance programs that are screened,
Screen for programs 1 and 2—all data items
Screen for program 1 only—data items 1-10
Screen for program 2 only—data items 11-20

In one embodiment, the locations of each particular data item in the organization unit determine the universe of categories, subcategories, and data sets that are presented to the user for data entry. In one example, indication of data items to be collected is implemented at the database level for efficiency and ease of maintenance. Changes to the data items to be collected as indicated by the database can be dynamically updated.

Form Profile Implementation

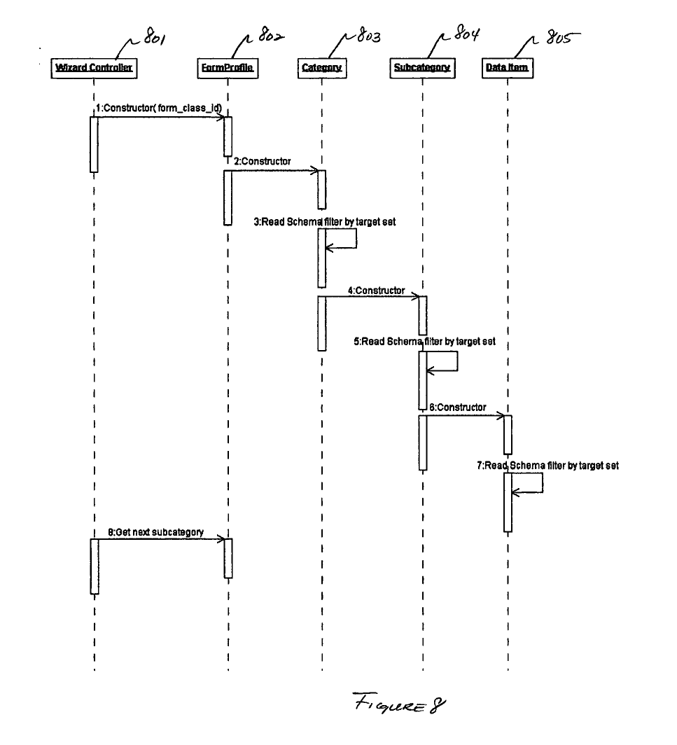

Data item organization and targeting are implemented, in one example, via a set of object classes, such as, for example, Java object classes. One example of various classes used to organize and store targeted data is shown in FIG. 7.

FIG. 7 shows a class diagram for organizing data relating to a targeted interview for multiple programs. In particular, a class hierarchy may include a FormProfile (element 701) that corresponds to a particular program (e.g., Food Stamps). Associated with this FormProfile are one or more Category objects (element 702) that represent categories of information that may be collected from an applicant. These Category objects may include one of more Subcategory objects (element 703) that may be used to describe instances or subelements of the Category. For example, when describing a Category of “Education,” there may be Subcategory objects created for high school and one or more colleges. There also may be Category objects with which there are no Subcategory objects, and in this case, there may be one Subcategory object defined for the Category object.

Each Subcategory object may be one or more DataItem objects (element 704) that represent questions that may be presented to an applicant. One or more of these Subcategory and DataItem objects (and optionally, the Category object) may be “targeted” based on what programs the applicant is being screened/applying for. To this end, Subcategory objects and DataItem objects may each store information indicating whether these questions or groups of questions should be targeted in the interview. Also, questions or groups of questions may be presented to an applicant based on his/her answers of previous questions. That is, the need to present particular questions and/or question groups may depend on the answers to previous questions, which are not determined apriori, but are instead determined during the interview.

Such a class hierarchy may be stored, for example, in a file memory, and/or database of a computer system. Although an example hierarchy is shown, it should be appreciated that other class hierarchies may be used.

The root class is Form Profile; it represents the schema of an interview and is a container for Categories, Subcategories and Data Items. The Form Profile is a dynamic database backed schema that the system framework will tailor based on the set of data elements (or “targets”) chosen. The Form Profile provides a schema that captures all the data needed to satisfy the targets in the shortest possible interview with no redundant elements. A UML class diagram for this framework is shown in FIG. 7.

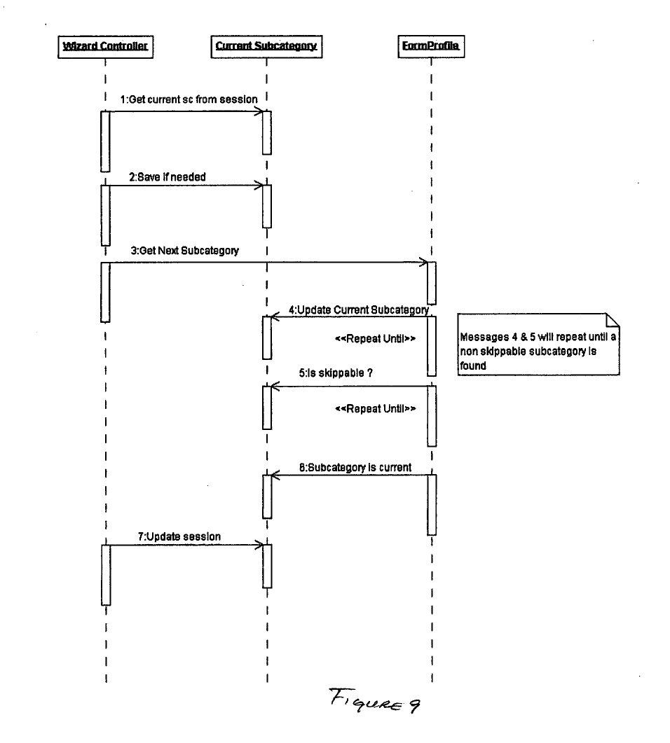

FIG. 8 shows a UML diagram that entails how a targeted interview may be built (e.g., as a result of processing the class hierarchy described above with reference to FIG. 7). In particular, a controller program (e.g., Wizard Controller 801) constructs a FormProfile (e.g., element 802) as discussed above. Based on the target information stored with each of the category (element 803), subcategory (element 804), and data item (element 805) objects, a program may determine the questions that are to be presented to the applicant.

Further, FIG. 9 is a UML diagram showing logic that may determine how subcategories may be skipped (and therefore, this information may not be presented to an applicant). More particularly, subcategories (or other objects) may be evaluated to determine whether they should be skipped, and therefore, not presented to the user for completion.

Benefits of intelligently determining data elements to be targeted among multiple programs include:
Users are presented an interview that is the minimum length required to collect all data needed to apply for each program targeted.
Users are not be asked any redundant questions
All data is collected in one initial pass
Application forms can be generated from the screening data in one step
   Targeted Interview

According to one embodiment, a “targeted interview” is determined that comprises several major class frameworks. These classes work together to delegate processing to an appropriate specialized framework.

Form Profile Framework—The root class is Form Profile which represents the schema of an interview and is a container for categories, subcategories and data items as discussed above. The Form Profile is a dynamic database backed schema that the system framework tailors based on the set of targets chosen. In one example, the Form Profile provides a schema that captures all the data needed to satisfy the targets in the shortest possible interview with no redundant elements.

Persistence Framework—The persistence framework is a set of core classes that provide persistence services to business domain objects that need to have a lifecycle beyond the scope of current execution. Persistence can be provided, for example, by any database that supports Java Database Connectivity (JDBC). However, other types of databases and/or access methods may be used.

UoSubcategory Framework—The UoSubcategory framework contains implementations of each subcategory within a “Targeted Interview”. A UoSubcategory instance provides an extension point for a subcategory to apply specific business processes. For example, framework methods provided a place to specify when a subcategory can be skipped or excluded from the interview.

Viewer Framework—The viewer framework provides the presentation layer for a given subcategory in a targeted interview. The viewer establishes a protocol for field exchange, and provides the mechanism for specifying that a field is targeted to a given assistance program. This field level targeting may be implemented, for example, via a JSP custom tag library.

Subcategory Example

The following illustrates an example subcategory within, for instance, the State of Massachusetts (MA). The household member subcategory (within the household category) in a MA targeted interview may contain the following components:

| Component Name | Framework | Description/Roles |
|---|---|---|
| Category | FormProfile | Provides schema-based data |
| | | about this household category |
| | | (Name, Icon, and Class name). |
| UoCategory | UoSubcategory | Class specified by |
| | | Category −> class name. |
| | | This Java class provides |
| | | extension methods to add |
| | | specific business processing |
| | | that will be triggered by the |
| | | framework as appropriate. For |
| | | example category is current |
| | | notification. |
| Subcategory | FormProfile | Provides schema information |
| | | with respect to this subcategory. |
| | | Name, icon, class name and |
| | | target text is provided. The |
| | | target text is key as it provides |
| | | the mechanism to indicate a list |
| | | of assistance programs that |
| | | subscribe to this subcategory. |
| | | The FormProfile iterator class |
| | | will use this information in |
| | | determining if this subcategory |
| | | is appropriate to display to the |
| | | user based on their target |
| | | selection and current data set. |
| UosmMAMember | UoSubcategory | Java class specified by |
| | | Subcategory −> class name. |
| | | This class provides extension |
| | | methods to allow specific |
| | | business processing to occur |
| | | based on framework methods. |
| | | For example add parents to |
| | | container allows specific |
| | | processing to determine what |
| | | acceptable parents for the |
| | | persistent data this subcategory |
| | | represents |
| V_ma_targ_member | Viewer | This JSP script is the |
| | | presentation layer that displays |
| | | the user interface. The key |
| | | integration with targeting is a |
| | | custom tag that allows |
| | | programmers to specify at |
| | | design time what assistance |
| | | programs subscribe to a set of |
| | | fields on the web page. |
| FormMemberMa | Persistent | This class represents the data |
| | | that is captured by the |
| | | subcategory. In this instance it |
| | | models the real world concept of |
| | | a person who is included in the |
| | | assistance unit. |

Efficient Path

One example method for determining the most efficient path for the screening may be implemented by several sets of algorithms.

A first set is, according to one example, based purely on the set of targets the user selects. For example, if a user selects MassHealth and Food Stamps, the system creates a list of program targets for each programs class identifier. This list of targets is provided to the constructor of the FormProfile object. This FormProfile uses the target list to modify an SQL query used to select the various FormProfile components (categories, subcategories, and dataitems). This modification causes categories, subcategories, and dataitems to be excluded from the SQL query if their target list does not contain an item from the users target selection. This method eliminates parts of the interview that are not needed at a database level.

A second set of algorithms may be provided by each UoSubcategory object. In one example, every subcategory in the FormProfile schema includes a corresponding UoSubcategory object that is created dynamically based on a class name specified in the schema. The UoSubcategory object may include several methods that can be used to determine if the subcategory to which the object is related should be skipped from the interview. The methods are as follows:
1) public boolean is Skippable( )—This method provides an extension point for business processing. For example, the is Skippable( ) method in an alien status subcategory contains business rules that could permit this subcategory to be skipped if the data in the model satisfies the business rule conditions.
2) public void AddParentsToContainer(Container c_in)—This method provides an extension point to specify rules and filters for what an acceptable parent object for the model behind this controller could be. In the case that no suitable parents satisfy the rules/filters, the subcategory is excluded and skipped.

A breakdown of a data set into a FormProfile (categories, subcategories, and dataitems) may be performed apriori, for example, by programmers and analysts. In one specific example, these roles may use spreadsheets (e.g., an Excel spreadsheet) or other tool to track and document the breakdown. This documentation may be then transferred into a FormProfile content management tool which creates the appropriate database structure.

The final piece of targeting exclusion is field level targeting. The prior discussion focused on the ability to exclude a major category, subcategory or data item based on a user's target selection. The field level targeting is also beneficial because such targeting allows a finer level of granularity of selection. More specifically, the programmer or analyst may specify what fields within a given subcategory are targeted by a given assistance program. This targeting allows a single subcategory to dynamically change its field set based on user target selection. This may be implemented, for example, using a custom JSP tag that surrounds the fields and permits the programmer to specify a subscribe list in the custom tag.

In summary, according to one embodiment of the invention, methods are provided for determining a shorter length interview having little to no redundancy in data gathering. Such methods are useful, for example, for any type of data entry system that requires data based on a variable number of required field set where the most efficient path and least number of fields is desired for the interview.

Shortest Path and Targeting Example

Assuming a basic example interview that contains 3 subcategories, a targeted interview and shortest path may be determined. This example interview is a combination of two public benefits programs, Food Stamps (FS), and Medicaid (M). The interview supports a data set that collects all the information needed for eligibility purposes, and to apply for each program. This interview may be constructed as follows:
Subcategory Name: Local Interview
Subcategory ID: 10
Targets: Food Stamps
Skipping Logic: Do not display if user indicated they could attend a local interview from subcategory 5 routing questions (not included in this example)
Description of Data elements: 1 drop down list with a set of reasons the local interview cannot be attended, a text entry for use when user selects “Other”
Subcategory Name: Health Insurance
Subcategory ID: 15
Targets: Medicaid
Skipping Logic: None
Description of Data elements: Insured name, insurance company name, insurance company phone # & address, group number, policy number, start date, end date
Subcategory Name: Other Income
Subcategory ID: 20
Targets: Food Stamps, Medicaid
Skipping Logic: None
Description of Data elements: Household member drop-down, income type drop down, income amount, income period, source of income (FS), when received (M)
Targeting and Shortest Paths

### All Programs

If the user chooses to target Food Stamps and Medicaid, and they indicate they cannot attend a local interview the interview set would be −10, 15, 20
If the user chooses to target Food Stamps and Medicaid, and they indicate they can attend a local interview the interview set would be −15, 20

### Food Stamps Only

If the user chooses to target Food Stamps and they indicate they cannot attend a local interview the interview set would be −10, 20
If the user chooses to target Food Stamps and they indicate they can attend a local interview the interview set would be −20

### Medicaid Only

If the user chooses to target Medicaid the interview set would be −15, 20

These simple example paths illustrate interviews where based on target selection (Food Stamps, Medicaid) and known data (local interview routing question) that contain the least number of questions and interview steps.

Page Level Target Optimization Examples

An additional optimization can be found in subcategory #20 as it contains an income type drop down. This drop-down will also be filtered based on target selection as follows:

| Income Type | Target Program |
|---|---|
| Wages (1) | FS, M |
| Self Employment (2) | FS, M |
| Railroad Retirement (3) | FS |
| Unemployment (4) | M |

The drop down list contains 1, 2, 3, 4 if the user chooses to target Food Stamps and Medicaid, 1, 2, 3 if the user chooses to target only Food Stamps, and 1, 2, 4 if the user chooses to target Medicaid only.

The data elements/fields contained on a given subcategory can also be targeted based on program selection. By selecting a particular program a custom tailored data set is produced on a subcategory page. Using the other income subcategory as an example yields:
Food Stamps and Medicaid
Household member drop-down, income type drop down, income amount, income period, source of income (FS), when received (M)
Food Stamps only
Household member drop-down, income type drop down, income amount, income period, source of income
Medicaid only
Household member drop-down, income type drop down, income amount, income period, source of income, when received

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Original Eighth Edition, August 2001), Section 2111.03.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. In a computer system, a method for determining eligibility requirements for a plurality of programs, the method comprising acts of:
storing, for a plurality of programs, a respective plurality of questions for each of the plurality of programs; and
determining, for at least two of the plurality of programs, an interview comprising a first set of questions, the first set of questions including a minimum set of questions that fulfill application requirements for the at least two of the plurality of programs.

2. The method according to claim 1, wherein the act of determining an interview comprises an act of determining one or more redundant questions among the respective plurality of questions for the at least two of the plurality of programs.

3. The method according to claim 1, further comprising an act of determining a dependency between at least two of the minimum set of questions.

4. The method according to claim 3, wherein the act of determining a dependency includes an act of determining an order that the at least two of the minimum set of questions should be presented to an applicant.

5. The method according to claim 1, wherein the minimum set of questions includes a minimum set of questions needed to complete an application for each respective one of the at least two of the plurality of programs, and to determine eligibility for the at least two of the plurality of programs.

6. The method according to claim 1, further comprising an act of presenting the minimum set of questions to an applicant within a single interview session.

7. The method according to claim 6, wherein the act of presenting further comprises an act of generating one or more interfaces including the minimum set of questions.

8. The method according to claim 3, further comprising an act of storing the dependency in a memory of the computer system.

9. The method according to claim 8, wherein the act of storing the dependency includes storing a relation between the at least two of the minimum set of questions in the memory of the computer system.

10. The method according to claim 6, further comprising an act of collecting, from the applicant, answers to the minimum set of questions.

11. The method according to claim 10, further comprising an act of determining eligibility of the applicant to the at least two of the plurality of programs based on the collected answers to the minimum set of questions.

12. The method according to claim 11, wherein the act of determining eligibility further comprises an act of determining that the applicant is eligible for one of the at least two of the plurality of programs, and wherein the method further comprises an act of preparing an application document including application information from the collected answers to the minimum set of questions, the application information being relevant to the one of the at least two of the plurality of programs.

13. The method according to claim 12, wherein the act of preparing the application document does not require a data collection act for collecting the application information to be performed after the act of determining eligibility of the applicant.

14. A computer-readable medium having computer-readable signals stored thereon that define instructions that, as a result of being executed by a computer, instruct the computer to perform a method for determining eligibility requirements for a plurality of programs, the method comprising acts of:
storing, for a plurality of programs, a respective plurality of questions for each of the plurality of programs; and
determining, for at least two of the plurality of programs, an interview comprising a first set of questions, the first set of questions including a minimum set of questions that fulfill application requirements for the at least two of the plurality of programs.

15. The computer-readable medium according to claim 14, wherein the act of determining an interview comprises an act of determining one or more redundant questions among the respective plurality of questions for the at least two of the plurality of programs.

16. The computer-readable medium according to claim 14, wherein the method further comprises an act of determining a dependency between at least two of the minimum set of questions.

17. The computer-readable medium according to claim 16, wherein the act of determining a dependency includes an act of determining an order that the at least two of the minimum set of questions should be presented to an applicant.

18. The computer-readable medium according to claim 14, wherein the minimum set of questions includes a minimum set of questions needed to complete an application for each respective one of the at least two of the plurality of programs, and to determine eligibility for the at least two of the plurality of programs.

19. The computer-readable medium according to claim 14, wherein the method further comprises an act of presenting the minimum set of questions to an applicant within a single interview session.

20. The computer-readable medium according to claim 19, wherein the act of presenting further comprises an act of generating one or more interfaces including the minimum set of questions.

21. The computer-readable medium according to claim 16, wherein the method further comprises an act of storing the dependency in a memory of the computer system.

22. The computer-readable medium according to claim 21, wherein the act of storing the dependency includes storing a relation between the at least two of the minimum set of questions in the memory of the computer system.

23. The computer-readable medium according to claim 19, wherein the method further comprises an act of collecting, from the applicant, answers to the minimum set of questions.

24. The computer-readable medium according to claim 23, wherein the method further comprises an act of determining eligibility of the applicant to the at least two of the plurality of programs based on the collected answers to the minimum set of questions.

25. The computer-readable medium according to claim 24, wherein the act of determining eligibility further comprises an act of determining that the applicant is eligible for one of the at least two of the plurality of programs, and wherein the method further comprises an act of preparing an application document including application information from the collected answers to the minimum set of questions, the application information being relevant to the one of the at least two of the plurality of programs.

26. The computer-readable medium according to claim 25, wherein the act of preparing the application document does not require a data collection act for collecting the application information to be performed after the act of determining eligibility of the applicant.
